(19) United States
(12) Patent Application Publication
(10) Pub. No.: US 2022/0381145 A1
(43) Pub. Date: Dec. 1, 2022

(54) MODULAR ROTARY ENGINE

(71) Applicant: ELLIS F WRIGHT, GARLAND, TX (US)

(72) Inventor: ELLIS F WRIGHT, GARLAND, TX (US)

(21) Appl. No.: 17/773,217

(22) PCT Filed: Nov. 2, 2020
(86) PCT No.: PCT/US20/58613

§ 371 Date: Apr. 29, 2022

Related U.S. Application Data
(60) Provisional application No. 63/105,866, filed on Oct. 26, 2020.
(60) Provisional application No. 62/928,800, filed on Oct. 31, 2019.

(51) Int. Cl. F01C 20/12; F01C 1/10

(52) U.S. Cl. CPC F01C 20/12; F01C 1/10

(57) ABSTRACT

Apparatus and associated methods relate to a modular rotary engine with a rotating valve shaft assembly. The rotating valve shaft assembly controls the timing of operations that alternately load and seal compressed air in a plurality of adjacent combustion chambers and alternately unload the high-temperature, high-pressure combustion gases from the adjacent combustion chambers into one or more expansion modules. The rotating valve shaft assembly includes at least two rotating valve shafts. Each rotating valve shaft includes ports that alternately open to allow a flow of compressed air from the compression module into a combustion chamber; and close to allow the injection of fuel into the combustion chamber and ignition of the compressed air and fuel mixture. The rotation of the drive shaft of the rotary engine is powered by the expansion of expanding combustion gases that turns the expansion rotor.

The present application claims priority to U.S. Provisional patent application 62/928,800 entitled Modular Rotary Engine filed Oct. 31, 2019 and U.S. provisional patent application 63/105,866 filed Oct. 26, 2020 entitled Modular Rotary Engine, which are herein incorporated by reference for all purposes.

### TECHNICAL FIELD

Various embodiments relate generally to rotary internal combustion engines, and more specifically, to a rotary engine having a plurality of modules.

### BACKGROUND

Increasing thermal efficiency is a key objective in the design and operation of engines, regardless of the type of engine. It is known that increasing the thermal efficiency of an engine has a direct impact on increasing power output, the power-to weight ratio, and reducing harmful emissions. Current environmental and fuel supply issues make it necessary and beneficial to continually identify improved engine designs and operating techniques for increasing the thermal efficiency of internal combustion engines.

Internal combustion rotary engines illustrate one example of an energy efficient alternative to conventional reciprocating piston-type engines. Internal combustion rotary engines are known to provide a relatively high power output for relatively small physical size. Furthermore, due to the rotating operation, rotary engines are capable of operating at high engine speeds relative to typical reciprocating engines. For these reasons, internal combustion rotary engines have been used in several modern day automotive applications and several internal combustion rotary engine designs have been suggested.

U.S. Pat. No. 6,347,611 to Wright discloses a rotary engine that includes and integrates a compressor, a compressed air tank, a plurality of expansion rotors, and a plurality of sets of adjacent combustion chambers attached to each expansion chamber. The compressed air tank delivers compressed air to the adjacent combustion chambers to accomplish ignition and combustion. The resulting hot combustion gases are then released from the adjacent combustion chambers into an expansion chamber. A rotating disk valve operates to regulate the flow of hot combustion gases to the expansion chamber. An improvement in metrics such as the power-to-weight ratio and thermal efficiency of the rotary engine is desired.

### SUMMARY

Apparatus and associated methods relate to a modular rotary engine with a rotating valve shaft assembly. The rotating valve shaft assembly controls the timing of operations that alternately load and seal compressed air in a plurality of adjacent combustion chambers and alternately unload the high-temperature, high-pressure combustion gases from the adjacent combustion chambers into one or more expansion modules. The rotating valve shaft assembly includes at least two rotating valve shafts. Each rotating valve shaft includes ports that alternately open to allow a flow of compressed air from the compression module into a combustion chamber and close to allow the injection of fuel into the combustion chamber and ignition of the compressed air and fuel mixture. The rotating valve port opens to release the hot combustion gases into one or more expansion modules. The rotation of the drive shaft of the rotary engine is powered by the expansion of expanding combustion gases that turns the expansion rotor.

Various embodiments may achieve one or more advantages. In one exemplary aspect, the compression of the air directly into the combustion chambers may increase the efficiency of the engine. For example, one of the most critical elements of efficiency is a smooth, unimpeded flow of air through the engine. Externally compressing air may require the engine to overcome a significant amount of inertia as the compressed air is moved from an external source to the internal combustion chambers. Additionally, as compressed air is moved through channels that are not straight or channels that have a reduced diameter, a significant loss of pressure may also occur. The engine may then compensate for the loss of air pressure and increased inertia which may result in reduced power output and efficiency. This loss of air pressure and increased inertia may be eliminated by directly compressing the air into the combustion chambers. Eliminating the loss of air pressure and increased inertia may be among the more important advantages of compressing air directly into the combustion chambers. It may also provide the additional advantage of eliminating any additional components to store the compressed air, and, accordingly, reduces the engine weight, the volume of the engine assembly, manufacturing cost, and engine complexity.

In various examples, the architecture adapted for modular arrangement and configuration of rotary engine assemblies with a compressor and one or more expansion chambers, or a single expansion chamber with one or more compression chambers. In various implementations, one or more rotating valve shaft assemblies may reliably synchronize a predetermined timing for admitting and/or exhausting gases from a combustion module directly coupled to both a compression module and an expansion module via the ports in the valve shaft.

In another exemplary aspect, it may also be desirable to reduce the amount of friction caused by unwanted torque exerted on the various moving parts of a rotary engine. Reducing friction between parts may result in increased power output and overall efficiency. The rotating valve shaft assembly produces very little friction and the bearings of the assembly are easily accessible for lubrication. The rotating valve shaft is linked directly to the drive shaft, and to the rotors by means of a serpentine belt. Hence, the timing of the rotating valve shaft may be easily managed and controlled by fewer components. This may result in a reduced overall engine volume and manufacturing cost.

The details of various embodiments are set forth in the accompanying drawings and the description below. Other features and advantages will be apparent from the following detailed description taken in conjunction with the accompanying drawings and claims.

### BRIEF DESCRIPTION OF THE DRAWINGS

For a more complete understanding of the disclosure and the advantages thereof, reference is now made to the accompanying drawings wherein similar or identical reference numerals represent similar or identical items.

FIG. 1 depicts a high-level block diagram of an exemplary modular engine assembly;

FIG. 2A depicts an exemplary high-level flow of the processing steps of the exemplary modular internal combustion engine;

FIG. 2B depicts a chart corresponding to FIG. 2A to illustrate the orientation of the ports of the rotating valve shafts based on rotor position;

FIG. 3 depicts an internal perspective view of a rotating valve shaft corresponding to an exemplary modular rotary engine in a one-compressor, one-expander configuration;

FIG. 4 depicts a front perspective view of an exemplary modular rotary engine in a one-compressor, one expander configuration;

FIG. 5 depicts a front perspective view of an exemplary modular rotary engine in a one-compressor, one expander configuration having six rotating valve shafts;

FIG. 6 depicts a cross-sectional view of a rotating valve shaft with attached combustion chamber;

FIG. 7 depicts a cross-sectional view of an exemplary combustion chamber of a modular rotary engine;

FIGS. 8A-8D depict an internal cross section of a compressor module of a modular rotary engine during a single 360-degree revolution of the compressor rotor;

FIGS. 9A-9D correspond respectively to FIGS. 8D-8D and depict an internal cross section of an expander module of a modular rotary engine during a single 360-degree revolution of the expander rotor;

FIG. 10 depicts an exemplary flowchart of the operation of the modular rotary engine assembly;

FIG. 11A depicts a side view of an exemplary modular rotary engine in a one-compressor, two-expander configuration;

FIG. 11B depicts a front view of an exemplary modular rotary engine with a one-compressor, two-expander configuration;

FIG. 11C depicts a front view of an exemplary modular rotary engine with a one-compressor, two-expander configuration having six rotating valve shafts;

FIG. 12 depicts an exploded view of the exemplary modular rotary engine assembly in a one-compressor, two-expander configuration;

FIG. 13 depicts an internal view of the rotating valve shaft corresponding to an exemplary modular rotary engine in a one-compressor, two-expander configuration;

FIG. 14 depicts a side view of the modular rotary engine in a one-compressor, two-expander configuration;

FIG. 15A depicts a front perspective view of an engine configuration with multiple engine units on the same drive shaft; and,

FIG. 15B depicts a side view of the engine configuration of FIG. 15A with the multiple engine units on the same drive shaft.

### DETAILED DESCRIPTION OF ILLUSTRATIVE EMBODIMENTS

Apparatus and associated methods relate to a modular rotary engine with a rotating valve shaft assembly. The rotating valve shaft assembly controls the timing of operations that alternate between loading and sealing compressed air from a compressor in a plurality of adjacent combustion chambers for a combustion event and then unloading the hot expanding combustion gases from the adjacent combustion chambers into one or more expansion modules. The rotating valve shaft assembly is located at respective top portions and bottom portions of the modular rotary engine. Each rotating valve shaft assembly includes at least two rotating valve shafts. Each rotating shaft includes ports that alternately open to allow a flow of air compressed within the compression module to a combustion chamber, closes to allow injection of fuel into the combustion chamber and ignition of the compressed air and fuel mixture within the combustion chamber, and opens to release the hot combustion gases into one or more expansion modules. The expanding combustion gases power the rotation of the engine drive shaft.

In this disclosure the term module is synonymous with the term chamber and is used interchangeably. Also, the term compression module is synonymous and used interchangeably with the term compressor. Likewise, the term expansion module is synonymous and use interchangeably with the term expander.

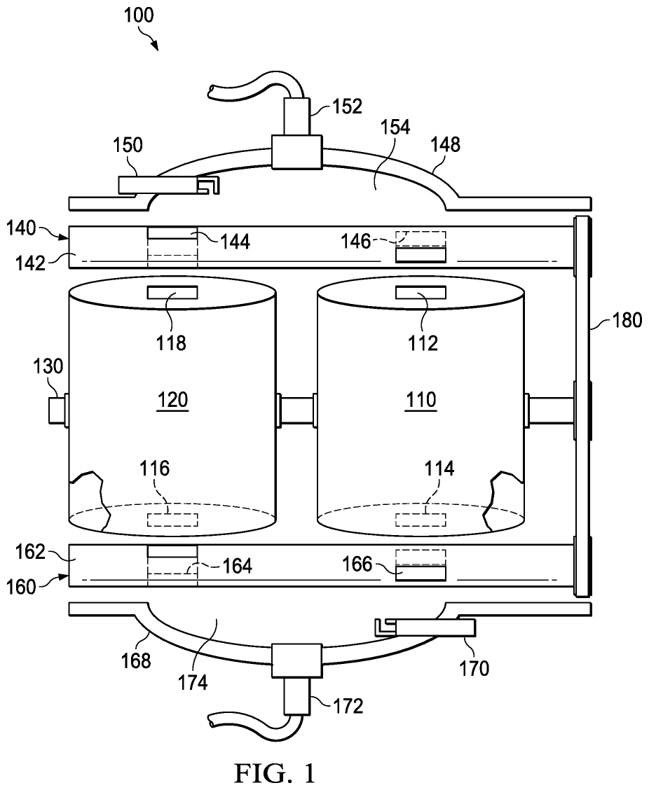

FIG. 1 depicts a high-level block diagram of an exemplary modular engine assembly. The modular engine assembly of FIG. 1 illustrates a one-compressor, one-expander configuration. The compressor may have a generally cylindrical cavity formed by opposing side walls and an inner surface of the generally cylindrical housing. The expander may have a configuration similar to the compressor with a generally cylindrical cavity formed by opposing side walls and the inner surface of the generally cylindrical housing.

The compressor and expander may be coupled together in a fixed position by one or more valve shaft assemblies that mount to the compressor and expander units at a top end portion and a bottom end portion of the compressor and expander housings. Each rotating valve shaft assembly may include a housing that encloses a generally cylindrical shaft extending longitudinally through the housing. The generally cylindrical shaft of the rotating valve shaft assembly may include slots or ports that align with the exhaust ports positioned or located at the top end and bottom end portions of the compressor and slots or ports that also align with the intake ports located at the top end portion and bottom end portion of the expander.

The compressor and expander may be connected together through a drive shaft that extends longitudinally through the generally cylindrical cavity of the compressor and expander. The end of the drive shaft and the end of each rotating valve shaft may be affixed with a pulley. In one illustrative embodiment, the pulley may be affixed to the compressor end of the engine configuration. A timing belt may extend around each pulley to control a sequence of rotation of the drive shaft and the top and bottom rotating valve assemblies.

The compressor may have at least two air intake ports for receiving ambient or outside air. Exhaust ports for the compressor may be positioned at a top end and a bottom end of the compressor for expelling compressed air. Conversely, the expander may have at least two exhaust ports through which residual exhaust gases are expelled. Intake ports for the expander may be positioned at a top end and bottom end of the expander for receiving expanding combustion gases.

The engine configuration of FIG. 1 further illustrates combustion modules that may be mounted on top of each respective rotating valve shaft assembly. Each combustion module may include a combustion chamber internal to the housing of the combustion module. The housing of each combustion module may include an opening for a fuel injector and a spark plug. Each expansion module may have at least four combustion chambers. Two of the combustion chambers may be affixed to the rotating valve shaft assembly located at, for example, the top end portion of the engine assembly. The additional two combustion chambers may be affixed to the rotating valve shaft assembly located at an opposing end, for example at a bottom end portion of the engine assembly.

In operation, compressed air may be loaded into the combustion chamber of the combustion module from a compressor exhaust port through a rotating valve shaft port. The rotating valve shaft may rotate to seal the compressed air in the combustion chamber.

Fuel may be injected into the combustion chamber by the fuel injector. The compressed air and fuel mixture may then be ignited by the spark plug. The rotating valve shaft may rotate to unload the expanding combustion gases from the combustion chamber into the expansion module through a slot or port in the rotating valve shaft and expander intake port.

The compressor and expander may each include a rotor (not shown) connected to the drive shaft that turns at the speed of the drive shaft. The speed of rotation of the drive shaft may be determined by a controller (not shown). Additionally, the housing of the compressor and expander may each include openings at diametrically opposed ends of the housing through which a vane is fitted. As the rotor rotates, the vane may slide into and out of the vane housing to expand or contract the cavity formed in the housing of the compressor and expander by, for example, dynamically providing a seal that extends between the rotor, which has a non-uniform radius, and a fixed location on the chamber wall.

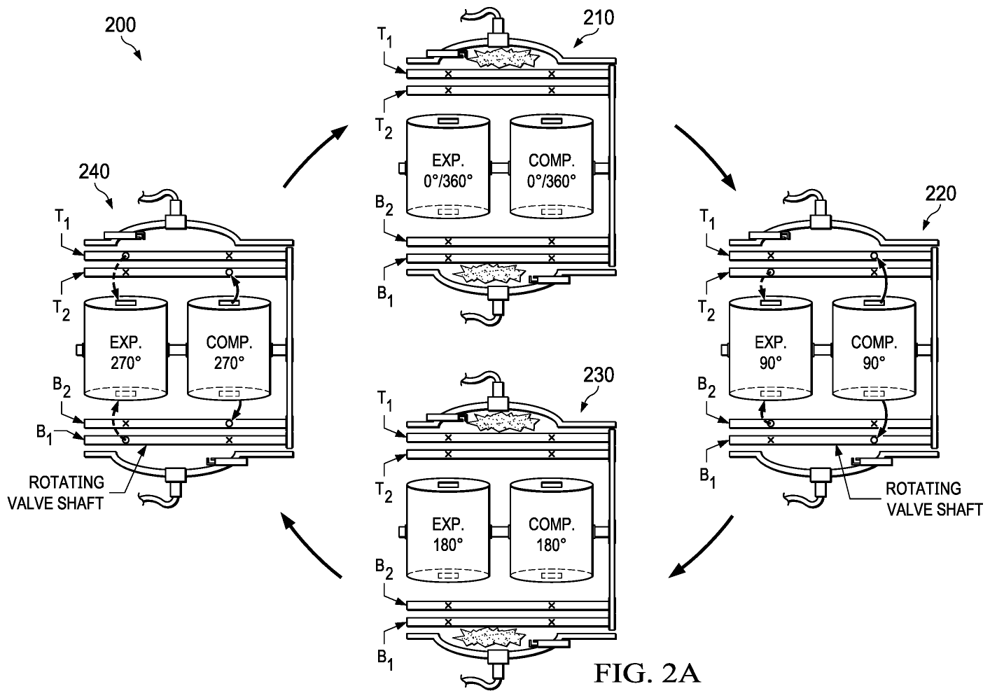

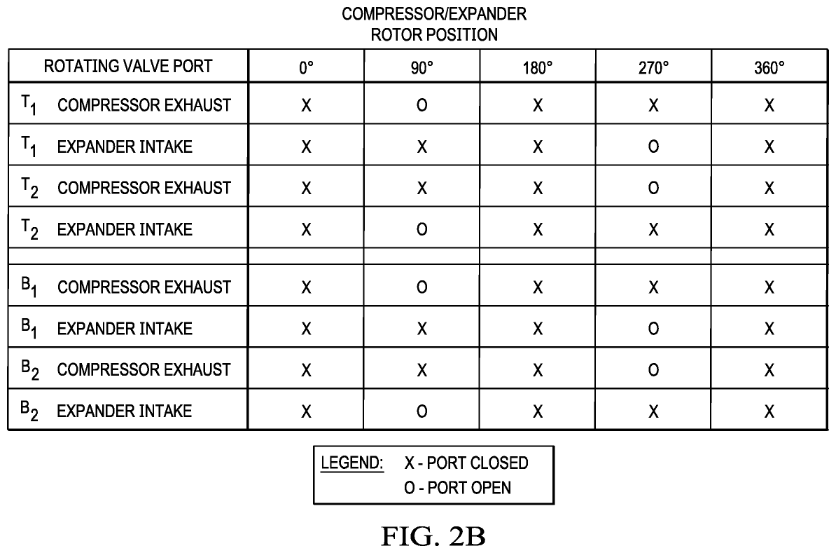

FIG. 2A depicts an exemplary high-level flow of the processing steps of the exemplary modular internal combustion engine. In one embodiment, the compressor rotor and expander rotor of the respective compression module and expansion module may be similar in configuration and rotate simultaneously about the drive shaft axis that extends through the compressor and expander. Each rotor may have at least two lobes. Those skilled in the art may appreciate that the configuration of the rotor is not limited to two lobes. Multiple lobes may be possible depending on the output power requirements.

The outer surface of the tip of each lobe of the rotor may interface with the walls of the generally cylindrical cavity and form a seal against the wall as the rotor rotates. The tip seal of the lobe may consist of various materials. In some embodiments, the tip seal may be a mechanical rigid part. In other embodiments, the tip seal may be a type of flexible structure. Other embodiments may use a dynamic air bearing. In a dynamic air bearing, the rotor is machined so that the rotor tip is so close to the wall of the housing that the air or combustion gases may not escape past the tip of the rotor when the engine is turning at normal operating speeds that may range from about several hundred revolutions per minute to about several thousand revolutions per minute.

In operation, the modular internal combustion engine of FIG. 2A performs a series of various engine operations or events sequentially. The events may include an intake phase, a compression phase, a combustion phase, a power phase and an exhaust phase. These events and phases may take place as the drive shaft and the rotors of the respective compression and expansion modules rotate through a 360-degree cycle.

In a first cycle of about 180 degrees (180°), or as the compressor rotor and expander rotor rotate through about 180° of rotation of the drive shaft, the rotating valve shaft rotates at about one-half the speed of the drive shaft. The rotating valve shaft may be controlled to open and close the slots or ports to the expander and compressor in an alternating manner that controls the flow of compressed air from the compressor to the combustion chamber and the flow of expanding combustion gases from the combustion chamber to the expander.

For example, with reference to the compressor, in a first cycle, only one rotating valve shaft port may be open at the top and bottom of the compressor for compressed air to pass through to a first pair of the combustion chambers located at a top and bottom of the engine assembly. The other rotating valve shaft port may be closed to block the flow of compressed air to the other combustion chambers. In a second cycle, the alternate rotating valve shaft ports that were previously closed on the top and bottom of the compressor may open to allow compressed air to flow through to the second pair of combustion chambers while the previously open rotating valve shaft ports may close to block the flow of compressed air into the first pair of combustions chambers.

Similarly, with reference to the expander, in a first cycle, only one rotating valve shaft port may be open at the top and bottom of the expander for heated or ignited gases to pass through from a first pair of combustion chambers into the expander while the other rotating valve shaft port may be closed to block any flow of compressed air from the other pair of combustion chambers. In a second cycle, the alternate rotating valve shaft ports that were previously closed on the top and bottom of the expander open to allow a flow of ignited gas from the combustion chamber through the expander intake ports while the previously open rotating valve shaft ports to the expander intake ports may close to block any flow from the other combustion chambers.

Phase events take place simultaneously in the compressor module and the expander module. More specifically, the intake phase and compression phase events may be taking place in the compressor simultaneously, or according to at least one predetermined synchronous timing relationship(s), with the power phase and exhaust phase in the expander.

During the intake phase and compression phase of the compressor, outside or ambient air may be automatically drawn or sucked into the compressor through the compressor intake port behind each tip seal of the rotor in the compressor. As the compressor intakes air behind each rotor tip seal, air is being pressurized in the cavity between a sliding vane and the front of the tip seal as the volume of space in the cavity decreases as the rotor turns. The pressurized or compressed air is funneled or directed through an exhaust port of the compressor and through an open port of the rotating valve shaft into a combustion chamber. In any one cycle, the compressed air from each cavity formed between a tip seal and a sliding vane of the compression chamber may be funneled into at least two combustion chambers, for example, an upper combustion chamber and a lower combustion chamber.

As the intake and compression phase occurs in the compressor, a power phase and exhaust phase may be occurring in the expander. Expanding combustion gases may be released from a combustion chamber through an open rotating valve port and an expander intake port. The expanding gases releases energy in the expander by turning of the expander rotor. The turning of the expander rotor powers the rotation of the drive shaft. As the ignited gas expands behind the top seal to the expander rotor, the expansion may power the rotation of the expander rotor and the rotation of the drive shaft. In front of the tip seal of the expander rotor, any residual exhaust gases may be driven out through the expander exhaust ports.

At the end of the first cycle, and prior to beginning a second cycle, all of the upper and lower rotating valve ports may be closed to the expander and the compressor. The closure of the upper and lower rotating valve shafts may trigger a combustion event in both the upper and lower combustion chambers. During the ignition event, fuel may be injected from the fuel injector into the combustion chamber and mixed with the compressed air. A spark may then be introduced by a spark plug to ignite the fuel-air mixture. A second cycle of about 180° of rotation with intake-compression events for the compressor and corresponding power-exhaust events for the expander may then commence. The compressor rotor and expander rotor may rotate in their respective housings at the same speed. One complete revolution of the rotor may be about 360 degrees.

FIG. 2B depicts a chart corresponding to FIG. 2A to illustrate the orientation of the ports of the rotating valve shafts based on rotor position. The rotating valve shafts are located at a top end and a bottom end of the compressor-expander assembly. Each compressor-expander assembly may have at least two rotating valve shafts at the top end and at least two rotating valve shafts at the bottom end. At the top end, each valve shaft may have at least one rotating valve port corresponding to the exhaust port from the compressor, and at least one rotating valve port corresponding to the intake port to the expander.

Similarly, at the bottom end, each valve shaft may have at least one rotating valve port corresponding to the exhaust port from the compressor, and at least one rotating valve port corresponding to the intake port to the expander. Each of the rotating valve ports at the top and the bottom alternately opens and closes to allow the flow of compressed air from the compressor to the combustion chamber and the flow of expanding combustion gases from the combustion chamber to the expander.

In a non-limiting example depicted in FIG. 2B, as the compression rotor, expansion rotor, and drive shaft rotate from 0 degrees to 360 degrees, the valve ports mounted to the top and bottom of the compressor are timed to open and close alternately. Starting with a rotor position of 0 degrees and/or 360 degrees, the rotating valve ports may all be closed to allow a combustion event to occur in the top and bottom combustion chambers. The closed rotating valve ports may seal the compressed air in the combustion chambers. Fuel may be injected into the combustion chamber and a spark plug ignites the fuel in the combustion chamber to produce high-temperature, high-pressure combustion gases. Similarly, at a rotor position of about 180 degrees, the rotating valve ports may also all be closed for a combustion event.

At rotor positions of 90 degrees and 270 degrees, respectively, the top and bottom valve ports corresponding to the compressor exhaust ports and the expander intake ports may be open or closed. For example, at a rotor position of 90 degrees, a slot or port in a first rotating valve shaft positioned on the top and bottom may open to a top compressor exhaust valve port and a bottom compressor exhaust port. The corresponding expander intake ports for each rotating valve shaft may be closed. In a second rotating valve shaft at the top and bottom, respectively, one top compressor exhaust port is closed and its corresponding expander intake port is open. At the bottom, a compressor exhaust valve port may be closed and its corresponding expander intake valve port may be open.

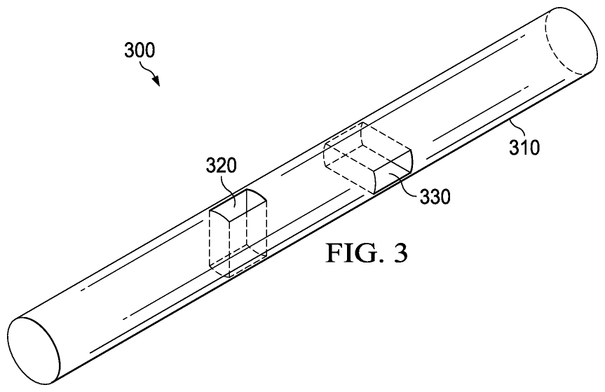

FIG. 3 depicts an internal perspective view of a rotating valve shaft corresponding to an exemplary modular rotary engine in a one-compressor, one-expander configuration. The rotating valve shaft may be a cylindrical solid that includes at least two slot openings cut through the solid. The slot openings may be oriented perpendicular to each other and positioned to correspond with port openings in the bottom of the combustion modules and port openings in the housing of the compressor and expander modules. The circumferential size of these slot openings may be designed to be open during a first 180° rotation of the drive shaft and to be closed during a second 180° rotation of the drive shaft, thus alternating between open and closed.

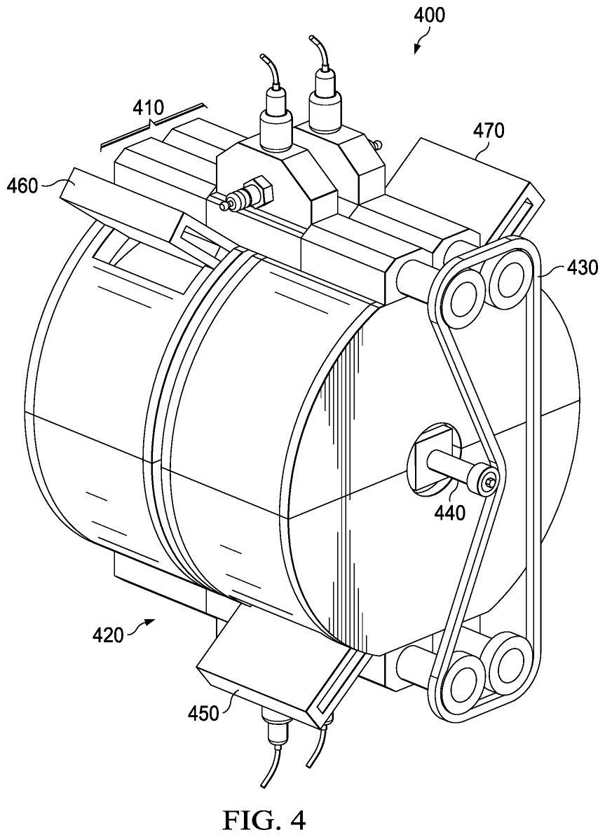

FIG. 4 depicts a front perspective view of an exemplary modular rotary engine in a one-compressor, one-expander configuration. The expander and the compressor are held together by rotating valve shaft assemblies mounted at the top and the bottom. Each rotating valve shaft assembly comprises at least two rotating valve shafts. Mounted to each valve shaft assembly are combustion modules. The compressor and the expander each include slot openings for one or more sliding vanes. Each rotating valve shaft and the drive shaft may be fitted with a pulley at one end. A serpentine belt wraps around each pulley and may be operative to regulate the timing of the opening and closing of the slots in the rotating valve shaft.

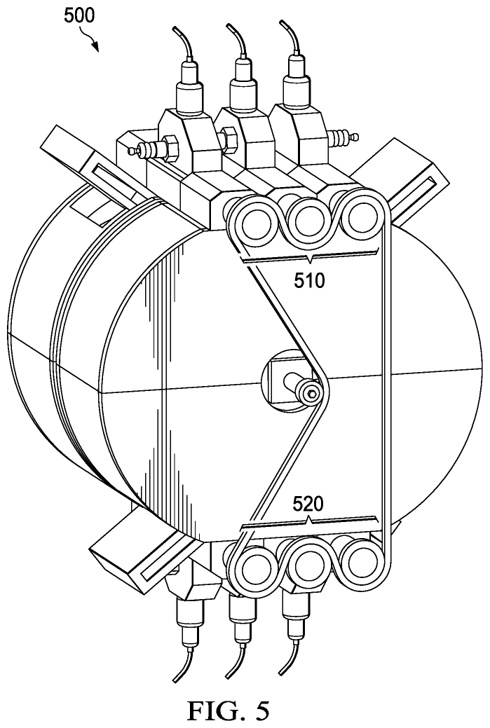

FIG. 5 depicts a front perspective view of an exemplary modular rotary engine in a one-compressor, one-expander configuration having three rotating valve shafts. In an exemplary embodiment, the rotating valve shaft assemblies mounted to the top and the bottom of the engine assembly may each include three rotating valve shafts. Intake ports and exhaust ports located at the top and bottom of each respective expander and compression module may form a channel with a corresponding combustion module mounted to the top of each of the rotating valve assemblies when a rotating valve shaft turns and the open slot port in the rotating valve shaft coincides with the opening of the combustion chamber in the combustion module. For example, intake ports of the expander and exhaust ports of the compressor may correspond with slots or ports in the rotating valve shaft as the compression and expander rotors together with the drive shaft rotate through about a 360° rotation.

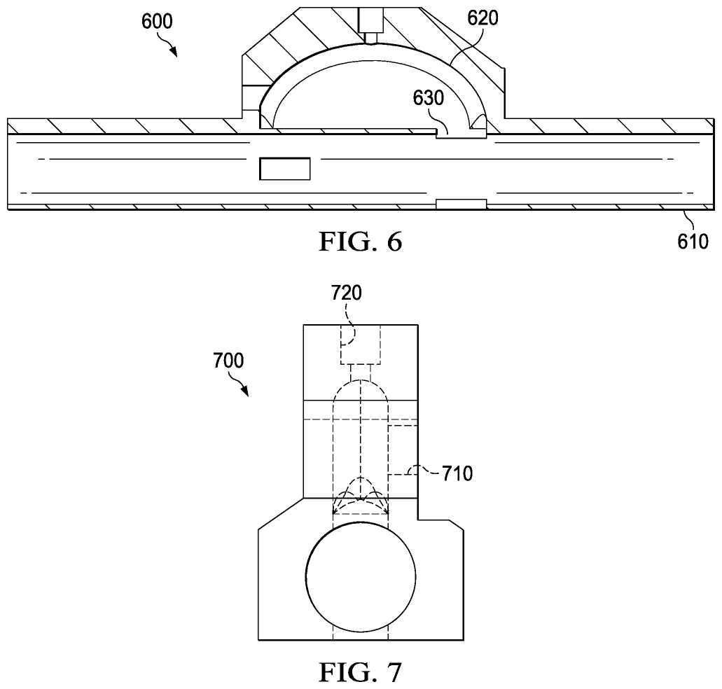

FIG. 6 depicts a cross-sectional view of a rotating valve shaft with attached combustion chamber. The rotating valve shaft includes a port that aligns with a compressor exhaust port to allow the flow of compressed air from the compressor into a combustion chamber. The rotating valve shaft also includes an output port that aligns with an opening to an expander intake port to allow the combustion chamber to release expanding gases into the expansion chamber.

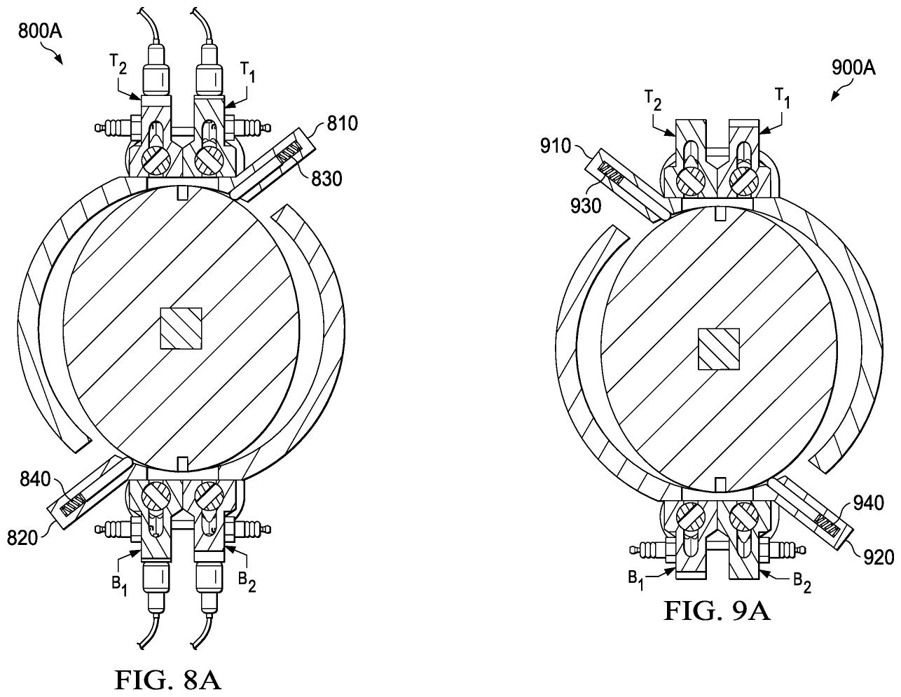

FIG. 7 depicts a cross-sectional view of an exemplary combustion chamber of a modular rotary engine. The combustion chamber includes openings that may form a channel with an open rotating valve shaft port. The combustion chamber includes an opening for a fuel injection device and an opening for a spark plug device. In operation, compressed air may be channeled into the combustion chamber from a compression chamber. When the opening to the combustion chamber closes, fuel may be injected into the combustion chamber and mixed with the compressed air. A spark plug may then be activated to produce a spark that ignites the compressed air and fuel mixture to produce combustion and expanding gases.

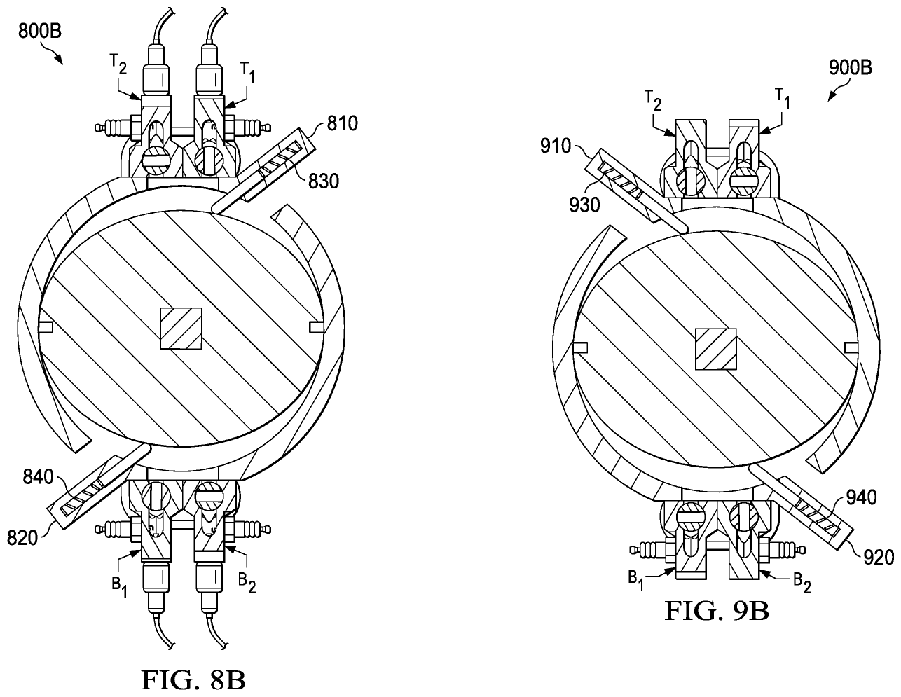

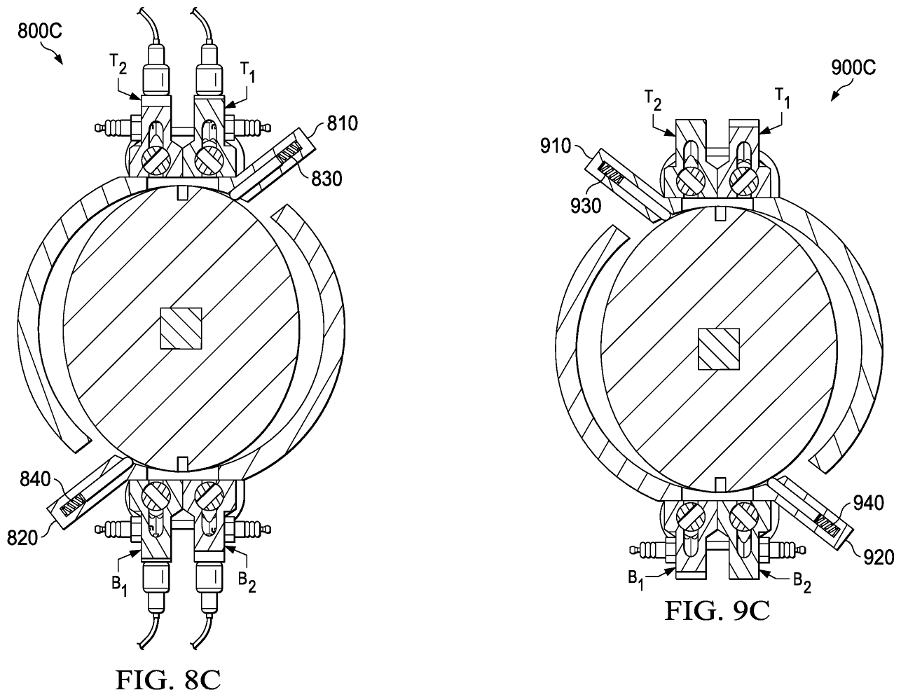

FIGS. 8A-8D depict an internal cross section of a compressor module of a modular rotary engine during a single 360-degree revolution of the compressor rotor. Similarly, FIGS. 9A-9D correspond respectively to FIGS. 8A-8D and depict an internal cross section of an expander module of a modular rotary engine during a single 360-degree revolution of the expander rotor. The sliding vanes attached to the compressor housing and the expander housing are configured to be positioned at opposing ends of the compressor module and the expander module, The sliding vanes may be impelled by a spring or by some other means to slide into and out of its housing to maintain constant contact with the surface of a rotor as the rotor rotates around the interior of the housing in conjunction with the rotation of the drive shaft.

The rotating valve shaft assemblies may be mounted to the top and the bottom of the engine assembly to hold the compressor module and expansion module together. A combustion module corresponding to each rotating valve shaft may be mounted on top of each rotating valve assembly. Each combustion module may also include an opening for at least one fuel injector to provide fuel to the corresponding combustion chamber of the module and at least one sparkplug to initiate a combustion event.

The housing of the compressor and expander may each include a rotor mounted to a generally cylindrical drive shaft extending through a center of the housing and rotor. The rotor may be multi-lobed. In the illustrative examples, the compressor and expander rotors may each include two lobes. However, it should be understood that the number of lobes indicated is merely illustrative and not intended to limit the scope of embodiments.

For example, a need for increased engine horsepower may result in the use of a 4-lobe, 8-lobe, or 16-lobe engine, as would be recognized by one of ordinary skill in the art. A cavity or pocket may be created internal to the compressor and expander between an engine assembly to allow compressed air to be input to a combustion chamber through an exhaust port of the compressor module or allow expanding combustion gases to be released from the combustion chamber through an intake port of an expander module.

Turning first to FIG. 8A, a cross section of the compressor housing illustrates a compressor rotor having two lobes. In FIG. 8A, the orientation of the rotor in the compressor may be at 0° at the top and 180° at the bottom. At a 0°/180° orientation, the rotating valve ports of the rotating valve assemblies at the top and bottom of the compressor and expander are closed. During the time that the rotating valve ports corresponding to the compressor are closed, fuel may be injected into the combustion chambers holding compressed air at a top and bottom of the engine assembly. In a one-compressor, one-expander configuration, there may be at least four combustion modules with corresponding combustion chambers.

The combustion modules may be mounted to their respective corresponding rotating valve assemblies. Two of the combustion modules may be located at the top of the engine assembly and two of the combustion modules may be located at the bottom of the engine assembly. Only one of the combustion chambers on the top of the engine assembly and one of the combustion chambers at the bottom of the engine assembly may be filled with compressed air when the rotating valve ports to the combustion chambers are all closed. The rotating valve ports may all close after every 180° rotation of the rotor to allow for combustion events to occur. The engine assembly alternates between the filling of compressed air between each set of combustion chambers at the top of the engine assembly and each set of combustion chambers at the bottom of the engine assembly.

The rotors of the compressor and expander turn simultaneously and may be at the same orientation. FIG. 9A illustrates the orientation of the rotor of the expander at 0° at the top and 180° at the bottom. During that time that the ports of the rotating valve assembly corresponding to the intake ports to the expander may also be closed at the top and bottom of the engine assembly, similar to the ports corresponding to the compressor exhaust ports.

As the rotors of the compressor module and the expander module rotate turning the drive shaft at least 90°, the rotating valve ports in the rotating valve assemblies at the top and bottom of the engine assembly may open and close in an alternating manner. FIG. 8B and FIG. 9B illustrate the orientation of the compressor rotor and the expander rotor at a 90° and 270° orientation and the position of the rotating valve ports within rotating valve shaft assemblies located at the top of the engine assembly and at the bottom of the engine assembly. The one-compressor one-expander configuration may have at least four rotating valve shaft assemblies: T1, T2 at the top of the engine assembly, and two rotating valve shafts assemblies, and B1, B2 at the bottom of the engine assembly. Since the rotating valve shafts turn at one-half the speed of the rotors and the drive shaft, the slots or ports in each valve shaft assembly, T1, T2, B1 and B2 are separated in orientation by 90°. Therefore, when a first port in a valve shaft assembly is open or may be opening to a port of the compressor or expander, the second port in the same valve shaft assembly is closed to the port of the compressor or expander located on the top end or bottom end of the engine assembly.

It should be recognized that the slots or ports of the valve shaft assembly are configured to be about 45° of circumferential width while the solid material of the drive shaft is about 135° of circumferential width. Therefore, as one set of rotating valve shafts are open or opening, the alternating set of rotating valve shafts may be completely closed to prevent the premature escape of compressed air before combustion occurs.

As the rotors of the compressor and expander rotate through a 360° cycle, the ports of a valve shaft assembly may alternate in opening and closing of a channel between the compressor to the combustion chamber and from the combustion chamber to the expander.

In the example of FIG. 8B, as the rotors of the compressor and expander rotate to a 90° orientation, the port of the T2 rotating valve shaft assembly that aligns with the compressor exhaust port may close to prevent the flow of compressed air into the combustion chamber while in FIG. 9B, the port of the T2 rotating valve shaft assembly that aligns with the expander intake port is open or may be opening to expel heated gases from the combustion chamber to the expansion chamber. The opening and closing operations of the ports of the T1 rotating valve assembly may be opposite to that of T2.

Turning again to the FIG. 8B and FIG. 9B, the port of the T1 rotating valve assembly that aligns with the compressor exhaust port may open or may be opening to input a flow of compressed air from the compressor as the corresponding T2 port closes. Similarly, the port of the T1 rotating valve shaft assembly that aligns with the expander intake port may close to prevent the premature escape of compressed air from the combustion chamber as the corresponding T2 port to the expander is open or may be opening.

The rotating valve shaft assemblies at the bottom of the engine assembly, B1 and B2 operate in the same manner as the top rotating valve assemblies, T1 and T2. More specifically, as the rotors of the compressor and expander rotate to a 90° orientation, the port of the B2 rotating valve shaft assembly that aligns with the compressor exhaust port may close to prevent the flow of compressed air into the combustion chamber while in FIG. 9B, the port of the B2 rotating valve shaft assembly that aligns with the expander intake port is open or may be opening to expel heated gases from the combustion chamber to the expansion chamber. The opening and closing operations of the ports of the B1 rotating valve assembly may be opposite to that of the B2 rotating valve assembly.

Turning again to the FIG. 8B and FIG. 9B, the port of the B1 rotating valve assembly that aligns with the compressor exhaust port may open or may be opening to allow a flow of compressed air from the compressor as the corresponding B2 port is closed. Similarly, the port of the B1 rotating valve shaft assembly that aligns with the expander intake port may be closed to prevent the premature escape of compressed air from the combustion chamber as the corresponding B2 port to the expander is open or may be opening.

In FIG. 8B, as the compression rotor rotates clockwise through to the 90° and 270° position, ambient air is drawn into the cavity behind each tip seal. Air may be compressed in the cavity of the compressor housing in between the rotor tip seal and the sliding vane through to a port of the rotating valve shaft that is open to the combustion chamber. The cavity formed in front of the tip seal and its respective sliding vane traps air and as the rotor rotates and the size of the cavity decreases, the trapped air may be pressurized or compressed and forced through the compressor exhaust port at the top and bottom ends of the compressor housing through an open rotating valve port.

Similarly, in FIG. 9B, expanding gases may be released from the combustion chamber into the expander behind the tip seals of the lobes of the rotor. The expanding gases may funnel through an open port of each rotating valve shaft assembly at the top and bottom of the engine assembly. The expanding gases may power the rotation of the expansion rotor and the drive shaft that extends through the center of the engine assembly.

In the illustrative example of FIG. 9B, expanding gases may be released from the combustion chambers through the port of the T2 rotating valve assembly and the port of the B2 rotating valve assembly and may work to power the rotation of the expansion rotor. In front of the tip seals of the expansion rotor lobes, residual gases from the previous cycle are driven into the outside environment through the expander exhaust ports.

FIG. 8C and FIG. 9C illustrate the rotors of the compressor and expander again at a 0° and 180° position of rotation. As the rotors rotate to a 0° and 180° position of rotation, the ports of the top rotating valve assemblies, T1 and T2, and the bottom rotating valve assemblies, B1 and B2 for the compressor and the expander may be rotating to a closed position. In the illustrative example of FIG. 8C, compressed air funneled from the compressor through the port of the T1 rotating valve assembly and the B1 rotating valve assembly may be sealed in the combustion chambers corresponding to the T1 rotating valve assembly and the B1 rotating valve assembly. In the illustrative example of FIG. 9C, the ports of the T1, T2, B1 and B2 rotating valve assemblies that may be aligned with the intake ports of the expander may be rotating to a closed position. Substantially all the residual or exhausted gases may already have been driven from the expansion module.

During the time that the rotating valve ports corresponding to the compressor are closed, fuel may be injected into the combustion chambers holding compressed air at a top and bottom of the engine assembly. The fuel-air mixture may be ignited in the combustion chambers by a sparkplug to produce high-temperature/high-pressure gases. FIG. 8D and FIG. 9D illustrate the position of the rotors of the compressor and expander as they continue to turn another 90° in a clockwise rotation. In the illustrative examples of FIG. 8D and FIG. 9D, the alternate ports corresponding to the T2 and B2 rotating valve assemblies that were not open in the previous rotation, may now open to air compressed from the compression chamber through the exhaust ports of the compressor into the combustion chamber. Simultaneously, the rotating valve ports corresponding to the T1 and B1 rotating valve assemblies that were closed to the expander in the previous rotation may now be open or opening and align with the intake ports of the expander to channel the hot expanding gases from the combustion chamber to the expander.

As the compressor rotor and the expander rotor continue to turn another 90° clockwise and completes a 360° cycle, the port closure and combustion events in the combustion chambers may repeat. All of the ports of all the rotating valve assemblies at the top and bottom of the compressor and expander may close. During the time all the rotating valve ports corresponding to the compressor and expander are closed, fuel may be injected into the combustion chambers holding compressed air at a top and bottom of the engine assembly. The fuel-air mixture may be ignited. The alternate ports of the rotating valve assemblies at the top and bottom of the compressor and expander may now rotate to an open or closed position as the rotors rotate another 90° in a clockwise rotation.

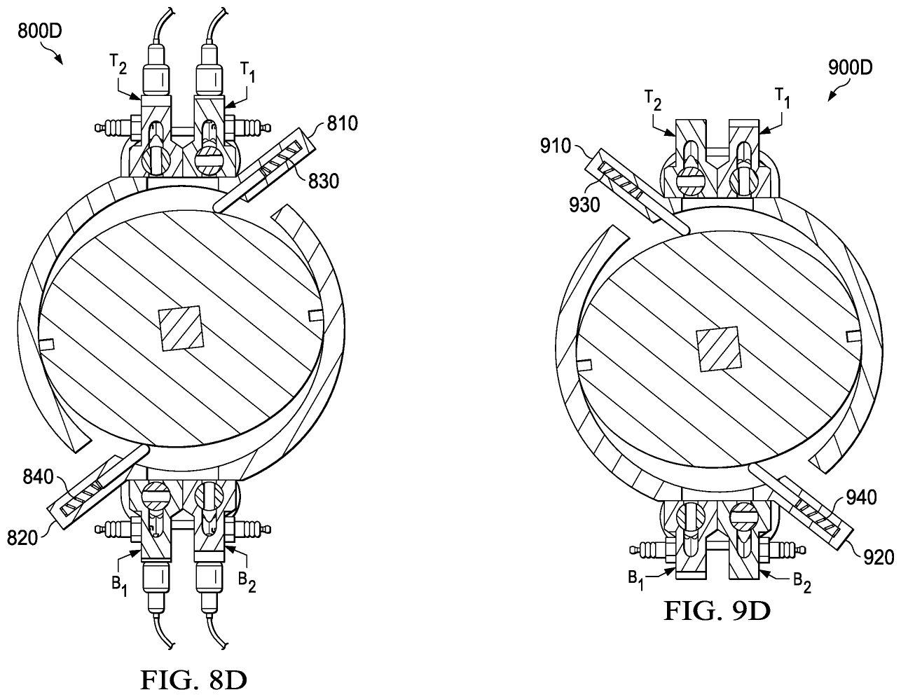

FIG. 10 depicts an exemplary flowchart of the operation of the modular rotary engine assembly. The engine assembly corresponding to the flowchart may be at least a one-compressor, two-expander configuration. In a one-compressor, two-expander configuration, the engine assembly may include two rotating valve shaft assemblies mounted to the upper section of the engine assembly and two rotating valve assemblies mounted to the lower section of the engine assembly.

In the configuration, each rotating valve shaft may include at least four slots or ports consisting of two compressor-expander port pairs where for each pair of ports or slots, one port of a pair corresponds to a compressor exhaust port and the other port of the pair corresponds with an expander intake port. Two combustion modules are mounted to the top of each rotating valve assembly to correspond with the two compressor-expander port pairs. The terms upper and lower are used to reference the location of the various modules; however, various embodiments may be arranged in orientations other than in vertical alignment parallel to a gravity vector, such as, for example, two combustion modules may be diametrically opposed and lying in a plane orthogonal or at an acute angle with respect to the gravity vector; furthermore, location of the combustion modules and corresponding rotating valve shaft assemblies may be disposed, in some embodiments, on opposing sides wherein the longitudinal axis (e.g., which may defined by the axis of rotation of the drive shaft) may lie in a plane (e.g., having a substantially vertical axis) other than a horizontal plane that is nominally oriented orthogonal to the gravity vector.

At a first stage of the operation, the engine cycle may be initiated by a starter motor that initiates at least one full power cycle to turn the drive shaft and rotors 180°. As the compression rotor turns, air is compressed in the compression module and driven through the open valve shaft ports into the upper combustion chamber and lower combustion chamber of the engine module. As the rotating valve shaft turns, the valve ports to the combustion chamber and from the combustion chamber may close trapping the compressed air in the combustion chambers.

At a next stage, fuel is injected to mix with the compressed air in the combustion chambers and a sparkplug provides the spark that ignites the compressed air and fuel mixture to produce high-temperature high-pressure gases. As the rotating valve shafts continue to rotate, an upper expander rotating valve and a lower expander rotating valve may open to the intake ports of the expander to allow the combustion chamber to expel the ignited gases into the upper and lower sections of the expander. The ignited gases may expand within the expansion chamber and drive the rotation of the rotor around the drive shaft. As the gases expand and turn the rotor, the compressor simultaneously may intake ambient air behind the tip seal of each lobe of the compressor rotor.

Simultaneously with the intake of air into the compressor, in front of the tip seal of each lobe of the compressor rotor, the compressor may compress air and funnel the compressed air through upper and lower compressor exhaust ports and open rotating valve ports into upper and lower combustion chambers of the engine assembly. The rotating valve shaft port pairs alternate in opening and closing to the compressor and the expander. For example, in a one-compressor, one expander configuration having an upper pair of rotating valve shaft assemblies on the top and a corresponding lower pair of rotating valve shaft assemblies on the bottom, a pair of rotating valve ports may alternate in their opening and closing. For example, if one of the ports in the pair of rotating valve ports is open to a compressor exhaust port, the other port in the pair of rotating valve ports corresponding to expander intake port is closed. Each pair of rotating valve ports may alternate between the opening of a channel to the compressor exhaust port and the opening of a channel to the expander intake port.

At a next stage, the ignited gases may be released into the expander behind the tip seals. The expanding gases behind the expansion rotor tip seals may turn the drive shaft through at least a 180° power cycle. Simultaneously to the turning of the drive shaft, in front of the tip seal of the expansion rotor, any residual exhaust gas from a previous power cycle are driven out through the expander exhaust port.

At a next stage, as the drive shaft and the rotating valve assemblies rotate, all rotating valve ports from the compressor exhaust ports and to the expander intake ports may close. Fuel may be injected into the alternating upper combustion chamber and lower combustion chamber and be ignited to create high-temperature high-pressure gases.

At a next stage as the rotors turn, the alternate upper combustion chambers and lower combustion chambers may expel the ignited gases through alternately open expander intake ports. As the ignited gases are expelled into the expander, the compressor simultaneously may compress air in front of tip seals into the alternate combustion chambers while intaking ambient air behind the tip seals of the compressor rotor as the rotor rotates through a 180° cycle.

At a next stage, the ignited gases released into the expander behind the tip seals may turn the drive shaft through at least a 180° power cycle. Simultaneously to the turning of the drive shaft, in front of the tip seal of the rotor, the expander may drive out any residual exhaust gas from a previous power cycle.

At a next stage, the operation cycle repeats with the closing of all rotating valve ports from the compressor exhaust ports and to the expander intake ports. Fuel may be injected into the alternating upper combustion chamber and lower combustion chamber and be ignited to create high-temperature high-pressure gases.

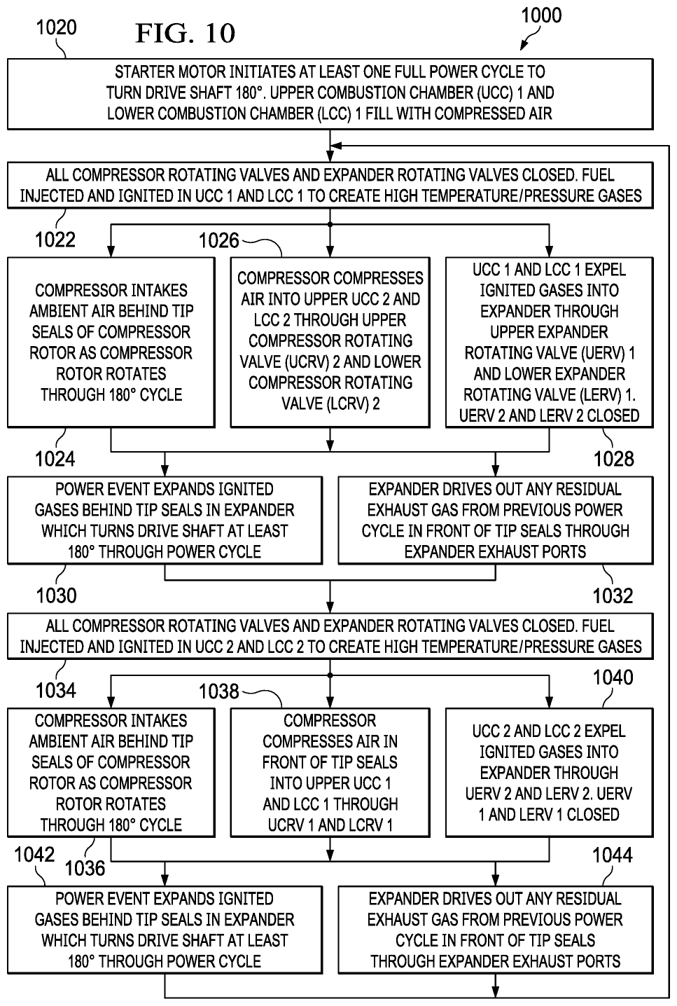

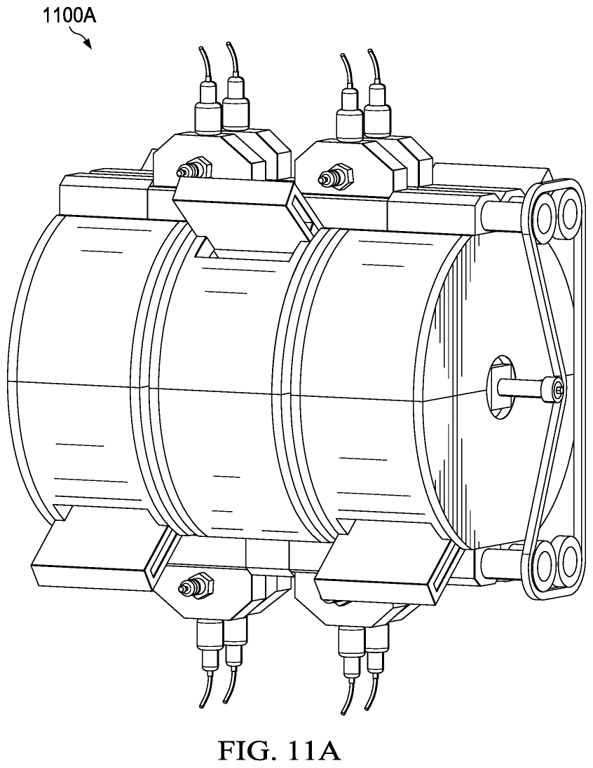

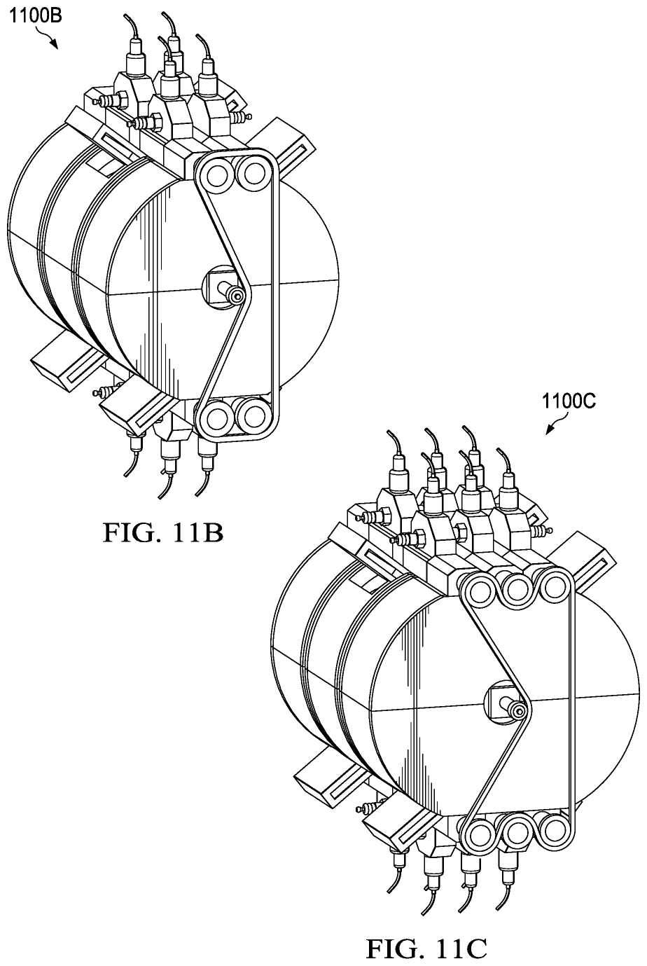

FIG. 11A depicts a side view of an exemplary modular rotary engine in a one-compressor, two-expander configuration. In the illustrative embodiment of FIG. 11A, the rotary engine assembly includes a compressor that is attached to a first expander at first end of the compressor and a second expander at a second end of the compressor opposite the first end. The compressor and each expander have an external housing that is substantially cylindrical in shape. Each housing of each respective module defines or encloses a generally cylindrical interior space or cavity.

In one embodiment, the compressor may include a multi-lobed rotor (not shown) that is operative to rotate around a longitudinal axis as may be indicated by the drive shaft that runs through the compressor, the first expander and the second expander. Similarly, the first expander and the second expander may each respectively include a multi-lobed rotor (not shown) disposed therein that is operative to rotate around a longitudinal axis proscribed by drive shaft. In this one compressor-two expander embodiment, the rotary engine may include a first rotary valve assembly pair at the top of the engine assembly and a second rotary valve assembly pair at the bottom of the engine assembly. Each rotary valve assembly pair may be enclosed in a housing.

Each rotary valve shaft at the top and bottom of the engine assembly may be affixed at the end with a pully. A serpentine timing belt may be wrapped around each respective pully pair to regulate the timing of the opening and closing of the rotating valve shaft ports. The top and bottom rotary valve assemblies are configured to connect together the one compressor with the two expanders to form the one compressor-two expander configuration.

A pair or set of combustion chambers are mounted to each rotary valve pair. At the top of the engine assembly, a pair of combustion modules may be mounted to a pair of respective rotary valve assemblies. Similarly, on the bottom or diametrically opposing side of the engine assembly, a second pair of combustion chambers may be mounted respectively to a pair of rotary valve assemblies. Each individual combustion chamber may be affixed with a fuel injector and a spark plug. The fuel injector may inject fuel into the combustion chamber to mix with the compressed air and create a fuel-air mixture. The spark plug ignites the fuel-air mixture and creates a combustion event within the combustion chamber.

FIG. 11B depicts a front view of an exemplary modular rotary engine with a one-compressor, two-expander configuration. In this illustrative embodiment, one compressor may service two expanders. The expanders may be located on opposite sides of the compressor. A pair of rotating valve shaft assemblies may be mounted to the top and bottom of the engine assembly. A timing belt may be attached to a pulley affixed to the ends of the rotating valve assemblies and the drive shaft to control the movement of the rotating valve shafts and regulate the opening and closing of its slots or ports. The pulleys are sized so that the timing belt may turn the rotating valve shafts at one-half the speed of the drive shaft.

FIG. 11C depicts a front view of an exemplary modular rotary engine with a one-compressor, two-expander configuration having six rotating valve shafts. Each rotating valve shaft assembly may have a respective pair of combustion modules affixed to it. In this illustrative embodiment, the compressor may compress air into a first pair of combustion modules during a first engine cycle; compress air into a second pair of combustion modules during a second engine cycle; and compress air into a third pair of combustion modules during a third engine cycle. Simultaneously, during a first engine cycle expanding gases may be released from a first pair of combustion modules into each of the expander modules.

During a second engine cycle expanding gases may be released from a second pair of combustion modules into each of the expander modules. And, during a third engine cycle expanding gases are released from a third pair of combustion modules into each of the expander modules. This embodiment may provide the advantage of allowing more time for the injection of fuel, mixing of the fuel with the compressed air, igniting of the fuel-air mixture, and combustion within the combustion chambers before the expanding gases are released into the expansion modules.

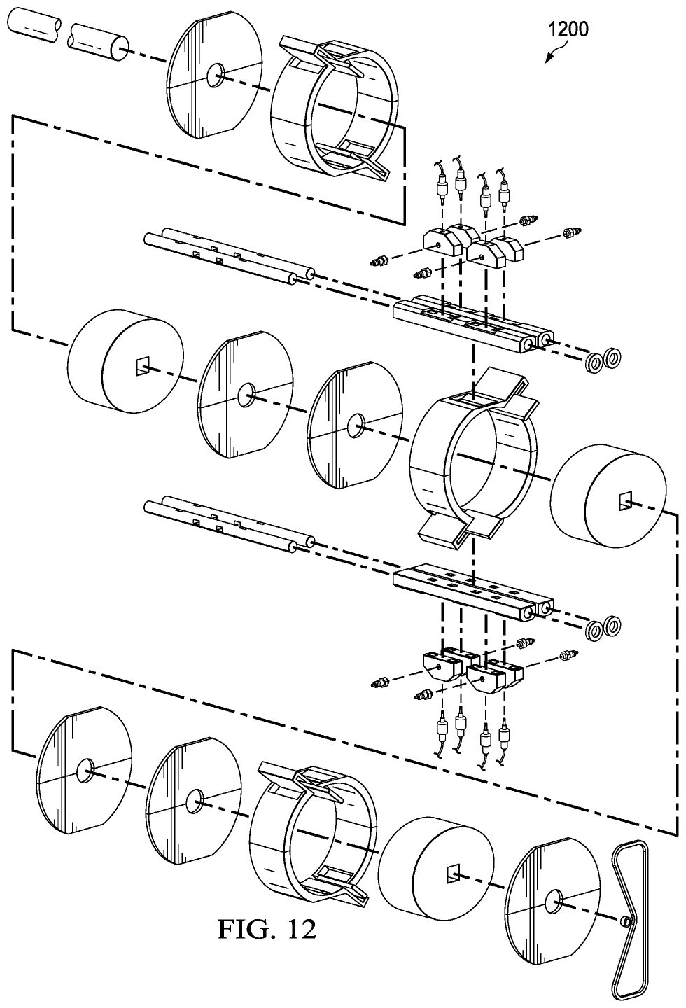

FIG. 12 depicts an exploded view of an exemplary modular rotary engine assembly in a one-compressor, two-expander configuration. In the illustrative embodiment, the modular rotary engine may include a compressor housing, a first expander housing, and a second expander housing. The housing of the compressor and expander are generally cylindrical in shape and may include a first and second sliding vane fitted into the housing and disposed at a tangential angle to the housing body. The housing of the compressor may also include openings for intake ports and exhaust ports at a top and bottom end of the housing. The housing of the expander may include openings for intake ports and exhaust ports at a top and bottom end of the housing.

The compressor housing includes first and second opposing end plates that define an interior space of the compressor. A compression rotor having at least two lobes may be disposed within the defined interior space. Similarly, the housings for the first expander and the second expander include first and second opposing end plates that define an interior space of the expanders. An expansion rotor having at least two lobes may be disposed within the defined interior space. The engine assembly may include a drive shaft that extends longitudinally through a centroidal axis of the compression rotor and the expansion rotor within the cylindrical cavity. The drive shaft may be affixed with a pulley at a first end.

A rotary valve shaft assembly may be affixed to the top and bottom of the rotary engine assembly and connect together the compressor and expanders. In the illustrative embodiment, there may be at least two rotary valve shaft assemblies at the top of the engine assembly and two rotary valve shaft assemblies at the bottom of the engine assembly. Each generally cylindrical shaft may have at least a first slot cut through the shaft at a first vertical position, a second slot cut through the shaft at an approximately 90-degree offset from the first open slot, a third slot cut through the shaft at a first vertical position, and a fourth slot cut through the shaft at an approximately 90-degree offset from the third open slot.

Each cylindrical shaft may be affixed with a pulley at one end. A timing belt may be coupled to and extend around the drive shaft pulley and the pulleys at the end of the rotary valve shaft. The timing belt may be operative to regulate the timing and sequence of the rotation of the rotary valve shafts within the rotary valve shaft assembly.

One or more combustion modules may be mounted to the top of each rotary valve shaft assembly to interface with each pair of slots in the rotary valve shaft. Each combustion module may include an opening for a fuel injector and an opening for a spark plug.

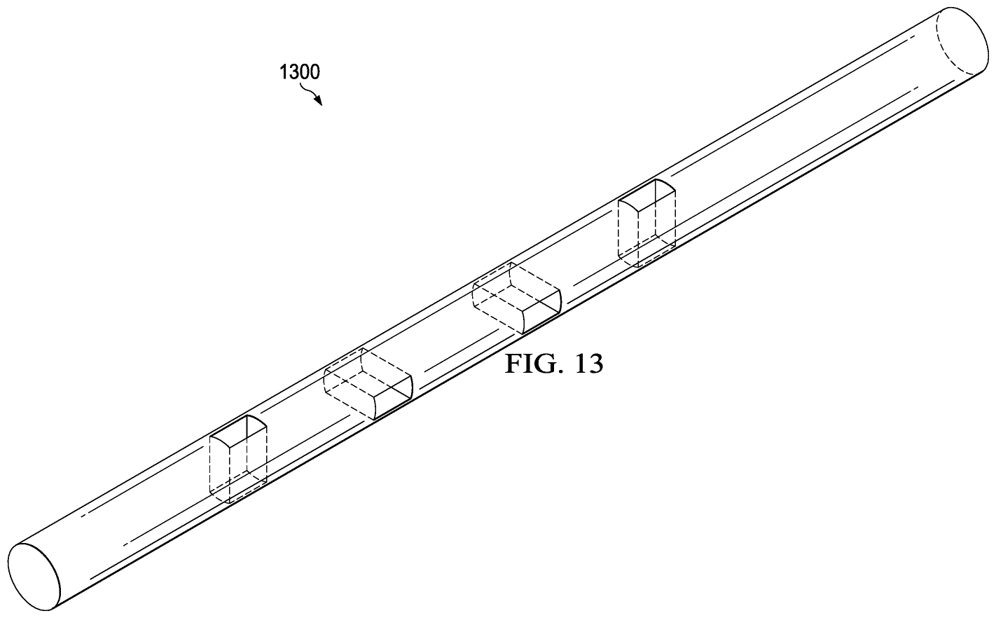

FIG. 13 depicts an internal view of the rotating valve shaft corresponding to an exemplary modular rotary engine in a one-compressor, two-expander configuration. The rotating valve shaft may generally be a cylindrical solid with slots or ports cut through the solid. Two slots may be cut through to align with exhaust ports of the compressor when the rotating valve shaft assembly is attached to the rotary engine. Two other slots may be cut through the solid to align with intake ports of the expander module or modules.

In the illustrative example of the one-compressor, two-expander configuration, the compressor is sandwiched in the center between two expanders located on either end. The rotating valve slots corresponding to the compressor exhaust ports may then be located in the middle of the shaft and the rotating valve slots corresponding to the expander intake ports may be located at opposite ends of the cylindrical shaft. The slots corresponding to the compressor ports may be cut at an approximately 90-degree offset from slots corresponding to the expander intake ports.

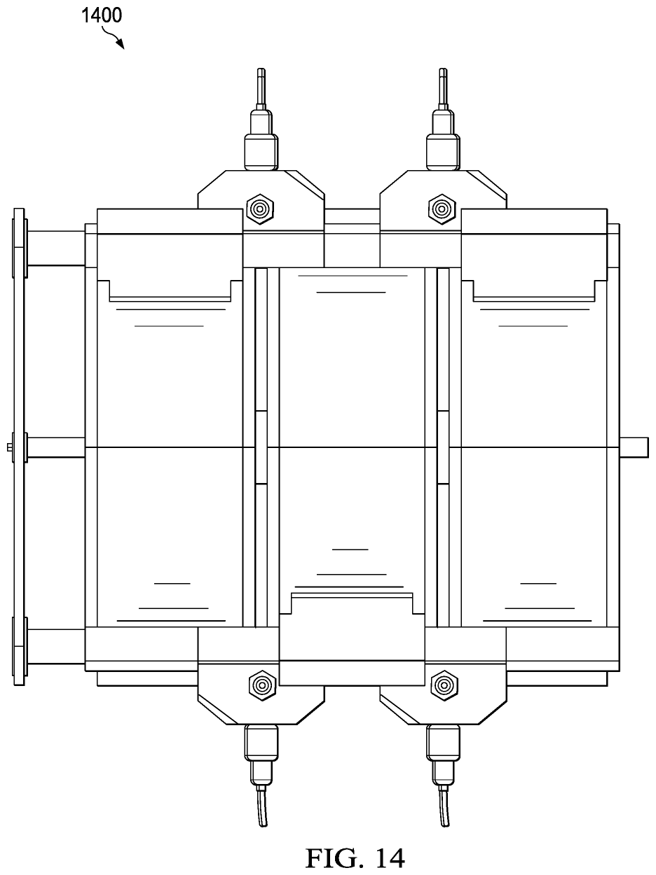

FIG. 14 depicts a side view of the modular rotary engine in a one compressor, two-expander configuration. In the illustrative embodiment, the compressor is depicted as being attached to an expander module at a front side of the compressor and at a second and opposite side of the compressor. A drive shaft extends along a centroidal axis connecting rotors within the compressor and expanders. The rotating valve shaft assemblies on the top and bottom of the rotary engine operatively couple the compressor and the expander modules together. The rotating valve shafts and the drive shaft may be affixed with pulleys at the end of each shaft. Combustion modules are mounted to each rotating valve assembly. Each combustion module includes a fuel injector and a spark plug to initiate combustion. A timing belt may be wrapped around each pulley to regulate the timing of the rotation of the rotating valve shafts.

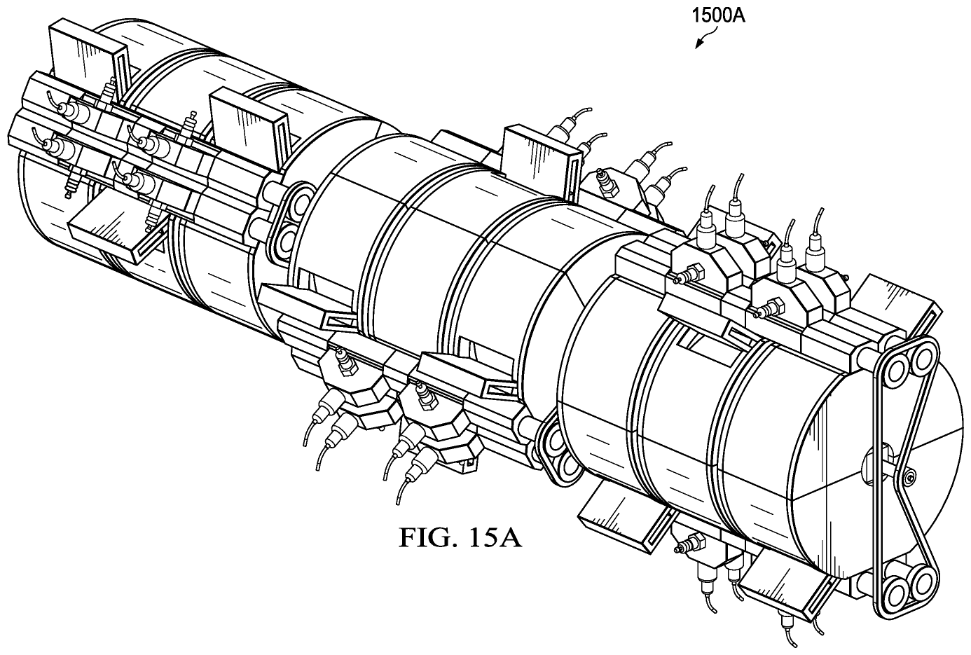

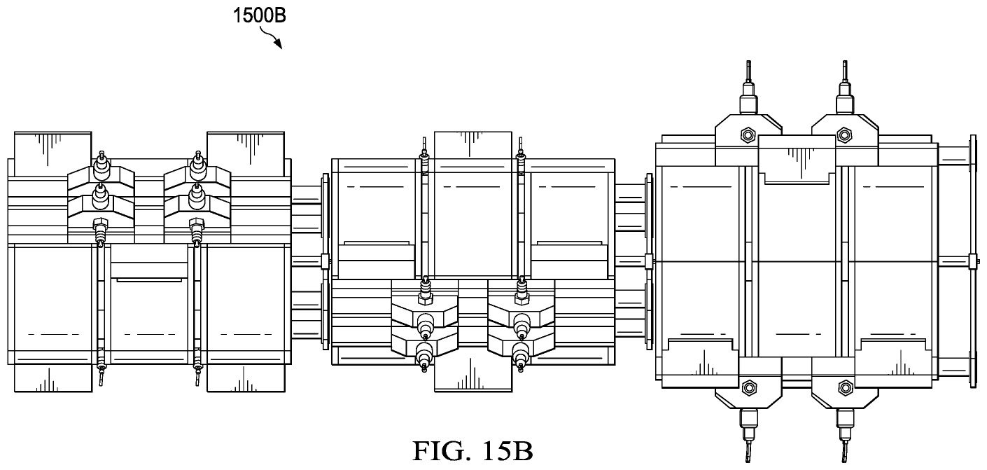

Turning now to the embodiments of FIG. 15, FIG. 15A depicts a front perspective of an engine configuration with multiple engine units on the same drive shaft. Two or more engine units may be configured on the same drive shaft. The combustion modules of the second engine unit may be offset by 90 degrees from the combustion modules of the first engine unit. Each engine may fire at a different point in the revolution. FIG. 15B depicts a side view of the engine configuration of FIG. 15A. In FIG. 15B, the combustion modules of the second and third engine units may be offset by 60 degrees and 120 degrees, respectively. The engine configuration may be long and narrow to allow for increasing power without increasing the diameter of the overall engine envelope.

Although various embodiments have been described with reference to the Figures, various other embodiments are possible and contemplated. For example, in one advantageous embodiment, increasing the number of lobes and sliding vanes in a compressor and expander may increases engine power, in some embodiments, exponentially, for example, by squaring the number of power events that may occur within an engine cycle without a dramatic increase in engine size. Increasing the number of lobes and sliding vanes requires a simultaneous increase in the number of combustors. By way of example and not limitation, in some embodiments, an engine may have 4, 8, 16 or more combustors or combustion modules.

In one exemplary aspect, a flow management apparatus for a rotary engine includes a compressor and an expander. The compressor includes a multi-lobe compressor rotor operatively coupled to rotate about an axis of a drive shaft within a cavity of the compressor. A tip of each lobe of the multi-lobe compressor rotor forms a seal against an inner surface of the compressor cavity. The compressor includes a compressor sliding vane that corresponds to each lobe of the rotor. For example, in a 3-lobe rotor, there are three sliding vanes. Each compressor sliding vane is configured to maintain a sealing contact with a surface of the multi-lobe compressor rotor. A void is formed between a lobe tip and its corresponding sliding vane in which the lobe tip compresses the air against the sliding vane.

Similarly, the expander includes a multi-lobe expander rotor operatively coupled to rotate about the drive shaft axis within a cavity of the expander. A tip of each lobe of the multi-lobe expander rotor forms a seal against an inner surface of the expander cavity. An expander sliding vane is included to correspond with each lobe, so the number of sliding vanes is equal to the number of lobes of the rotor. Each expander sliding vane is configured to maintain a sealing contact with a surface of the multi-lobe expander rotor. In front of the lobe tip and its corresponding sliding vane, a void is formed from which exhausted gases from a previous engine cycle are expelled.

The apparatus additionally includes a set of N combustors, where N is an integer greater than or equal to 2. Each set N combustors is axially opposed and radially offset with respect to the drive shaft axis. Each combustor of the set of N combustors comprises a combustion chamber.

The apparatus additionally includes a rotary valve shaft corresponding to each combustor of the set of N combustors. Each of the corresponding rotary valve shafts is laterally opposed to the other and configured to rotate about a corresponding valve shaft axis radially offset from and extending longitudinally parallel to the drive shaft. Each of the rotary valve shafts includes at least one compressor port of diameter 360/2N (where N is an integer greater than or equal to 2) extending through each corresponding valve shaft in a first orientation and configured to provide fluid communication from the compressor cavity to the combustion chamber; and at least one expander port of diameter 360/2N (where N is an integer greater than or equal to 2) extending through each corresponding valve shaft in a second orientation and configured to provide fluid communication from the combustion chamber to the expander cavity, wherein the first orientation and the second orientation are separated by 90 degrees, each corresponding valve shaft rotating in phase quadrature in a phase rotation of the expander rotor and the compressor rotor.

In some embodiments, in a first orientation and a first-degree phase rotation, the at least one compressor port allows fluid communication between the compressor cavity and combustion chamber and the at least one expander port simultaneously prevents fluid communication between the combustion chamber and the expander cavity.

In some embodiments, in a second orientation and a second-degree phase rotation, the at least one compressor port prevents fluid communication between the compressor cavity and combustion chamber and the at least one expander port allows fluid communication between the combustion chamber and the expander cavity.

In some embodiments, N=3, wherein N represents a set of combustors. In some embodiments, each lobe of the multi-lobe rotor of the compressor is adapted to rotatively pressurize air trapped between the tip seal of each lobe and its corresponding sliding vane into a combustion chamber when at least two of the valve shafts are in the first orientation.

In some embodiments, each combustor comprises an ignition system that creates high-temperature, high-pressure gases. In some embodiments, the ignition system comprises a fuel injector and a spark plug.

In some embodiments, the flow management apparatus additionally includes a timing belt attached around a pulley affixed to an end of each rotary valve shaft and drive shaft to sequence an orientation and rotation of the at least one compressor port and the at least one expander port of each corresponding valve shaft.

In one exemplary aspect, a method of operating a flow management apparatus of a rotary engine includes executing at least four power strokes of a rotor during a revolution of 360 degrees of rotation of a drive shaft. Each revolution of 360 degrees of rotation of the draft shaft rotates a first set of N valve shafts, where N is an integer greater than 1, and a corresponding second set of N valve shafts at one-half the revolution of the drive shaft rotation. The first set of N drive shafts and the second set of N draft shafts are diametrically opposed about the at least one compressor and one expander. Each valve shaft in the first set of N valve shafts and the second set of N valve shafts have at least two slot openings offset by 90 degrees. Each slot opening aligns with a port of a corresponding combustor module to allow fluid communication in a first orientation and prevent fluid communication in a second orientation. The first orientation and second orientation correspond to a position of a multi-lobe rotor within an expander and a compressor.

In one embodiment, N, which represents the number of drive shafts mounted to the rotary engine, is an integer equal to 2. In one embodiment, N is an integer equal to 3.

In one embodiment, each slot opening of the rotary valve shaft is cut to equal to 360/2N, where N is the number of lobes of the rotor in the combustor and the expander. In one embodiment, at a multi-lobe rotor position of 90 degrees, the slot openings of the first set of N valve shafts with a first orientation are open, and the second set of N valve shafts with a second orientation are closed.

In an exemplary aspect, a flow management apparatus for a rotary engine includes a compressor with a multi-lobe compressor rotor operatively coupled to rotate about an axis of a drive shaft within a cavity of the compressor, wherein a tip of each lobe of the multi-lobe compressor rotor forms a seal against an inner surface of the compressor cavity; and a compressor sliding vane corresponding to each lobe, each compressor sliding vane configured to maintain a sealing contact with a surface of the multi-lobe compressor rotor, wherein a void is formed between a lobe tip and its corresponding sliding vane in which air is compressed. The flow management apparatus further includes an expander with a multi-lobe expander rotor operatively coupled to rotate about the drive shaft axis within a cavity of the expander, wherein a tip of each lobe of the multi-lobe expander rotor forms a seal against an inner surface of the expander cavity, and, an expander sliding vane corresponding to each lobe, each expander sliding vane configured to maintain a sealing contact with a surface of the multi-lobe expander rotor, wherein a lobe tip and its corresponding sliding vane form a void in front of the lobe tip from which exhausted gases are expelled. The flow management apparatus further includes a set of N combustors, each set of N combustors axially opposed and radially offset from the drive shaft axis, each combustor of the set of N combustors comprising a combustion chamber, wherein N is an integer greater than or equal to two. The flow management apparatus further includes a rotary valve shaft corresponding to each combustor of the set of N combustors, each of the corresponding rotary valve shafts laterally opposed to the other and configured to rotate about a corresponding valve shaft axis radially offset from and extending longitudinally parallel to the drive shaft. Each of the corresponding rotary valve shafts includes at least one compressor port extending through each corresponding valve shaft in a first orientation and configured to provide fluid communication from the compressor cavity to the combustion chamber; and, at least one expander port extending through each corresponding valve shaft in a second orientation and configured to provide fluid communication from the combustion chamber to the expander cavity, wherein the first orientation and the second orientation are separated by 90 degrees, each corresponding valve shaft rotating in phase quadrature in a phase rotation of the expander rotor and the compressor rotor.

In various examples, the at least one compressor port and/or expander port may have a diameter 360/2N. In a first orientation and a first-degree phase rotation, the at least one compressor port may allow fluid communication between the compressor cavity and combustion chamber and the at least one expander port simultaneously prevents fluid communication between the combustion chamber and the expander cavity. In a second orientation and a second-degree phase rotation, the at least one compressor port may prevent fluid communication between the compressor cavity and combustion chamber and the at least one expander port allows fluid communication between the combustion chamber and the expander cavity. N may be equal to 3. Each lobe of the multi-lobe rotor of the compressor may be adapted to rotatively pressurize air trapped between the tip seal of each lobe and its corresponding sliding vane into a combustion chamber when at least two of the valve shafts are in the first orientation. Each combustor may include an ignition system that creates high-temperature, high-pressure gases. The ignition system may include a fuel injector and a spark plug.

The flow management apparatus may further include a timing belt attached around a pulley affixed to an end of each rotary valve shaft and drive shaft to sequence an orientation and rotation of the at least one compressor port and the at least one expander port of each corresponding valve shaft.

In another exemplary aspect, a method of operating a flow management apparatus of a rotary engine includes a step of executing at least four power strokes of a rotor during a revolution of 360 degrees of rotation of a drive shaft, each revolution of the draft shaft rotating a first set of N valve shafts and a corresponding second set of N valve shafts at one-half the revolution of the drive shaft rotation, the first set of N drive shafts and the second set of N draft shafts being diametrically opposed about at least one compressor and one expander, each valve shaft in the first set of N valve shafts and second set of N valve shafts having at least two slot openings offset by 90 degrees, each slot opening aligning with a port of a corresponding combustor module to allow fluid communication in a first orientation and prevent fluid communication in a second orientation, the first orientation and second orientation corresponding to a position of a multi-lobe rotor of an expander and a compressor, wherein N is an integer greater than 1.

In various embodiments, the method may include N=2 or 3. Each slot opening may be cut to equal to 360/2N, where N is the number of lobes of the rotor in the combustor and the expander. At a multi-lobe rotor position of 90 degrees, the slot openings of the first set of N valve shafts with a first orientation may be open, and the second set of N valve shafts with a second orientation may be closed.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A flow management apparatus for a rotary engine, comprising:
a compressor, comprising:
a multi-lobe compressor rotor operatively coupled to rotate about an axis of a drive shaft within a cavity of the compressor, a tip of each lobe of the multi-lobe compressor rotor forming a seal against an inner surface of the compressor cavity;
a sliding vane corresponding to each lobe of the multi-lobe compressor rotor, each compressor sliding vane configured to maintain a sealing contact with a surface of the multi-lobe compressor rotor, wherein a void is formed between a lobe tip and its corresponding sliding vane in which the lobe tip compresses air against the sliding vane;
an expander comprising:
a multi-lobe expander rotor housing operatively coupled to rotate about the drive shaft within a cavity of the expander, a tip of each lobe of the multi-lobe expander rotor forming a seal against an inner surface of the expander cavity;
a sliding vane corresponding to each lobe of the multi-lobe expander rotor, each expander sliding vane configured to maintain a sealing contact with a surface of the multi-lobe expander rotor, wherein a void is formed in front of the lobe tip and its corresponding sliding vane from which exhausted gases from a previous engine cycle are expelled.

2. The flow management apparatus of claim 1, further comprising a set of N combustors, wherein N is an integer greater than or equal to 2, each set of N combustors axially opposed and radially offset with respect to the drive shaft axis, wherein each combustor of the set of N combustors comprises a combustion chamber.

3. The flow management apparatus of claim 2, wherein N=3.
